(19) United States
(12) Patent Application Publication
(10) Pub. No.: US 2017/0158326 A1
(43) Pub. Date: Jun. 8, 2017

(54) APPARATUS FOR REMOTE SENSING USING DRONE

(71) Applicant: Korea Aerospace Research Institute, Daejeon (KR)

(72) Inventors: Sang Cherl LEE, Daejeon (KR); Sun Hee WOO, Daejeon (KR); Sang Il AHN, Daejeon (KR); Eun Kyou KIM, Daejeon (KR); Young Min CHO, Daejeon (KR); Dae Hwan HYUN, Daejeon (KR); Jin Ho LEE, Daejeon (KR); Hae Jin CHOI, Daejeon (KR)

(21) Appl. No.: 15/230,439

(22) Filed: Aug. 7, 2016

(30) Foreign Application Priority Data
Aug. 7, 2015 (KR) 10-2015-0111726

(51) Int. Cl. B64C 39/02; B64D 17/00; B64F 1/00

(52) U.S. Cl. CPC B64C 39/024; B64F 1/005; B64D 17/00; B64C 2201/024; B64C 2201/108; B64C 2201/122; B64C 2201/18; B60L 2230/22; B60L 2200/10

(57) ABSTRACT

Disclosed herein is an apparatus for remote sensing using a drone. An apparatus for remote sensing using a drone includes: a drone station which communicates with a server through a satellite and includes a containment portion at an upper portion and a post portion at a lower portion; and a drone which is contained in a containment portion of the drone station and communicates with the drone station, and further includes: a solar panel which is installed at the drone station and converts solar energy into electric energy; an capacitor which is installed at the drone station and stores electric energy generated by the solar panel; and a charging container access deck which is installed at the containment portion and charges the drone.

### RELATED APPLICATION

This application claims the benefit of priority of Korean Patent Application No. 10-2015-0111726 filed Aug. 7, 2015, the contents of which are incorporated herein by reference in their entirety.

### FIELD AND BACKGROUND OF THE INVENTION

The present invention relates to an apparatus for remote sensing using a drone.

More particularly, the present invention relates to an apparatus for remote sensing using a drone which is loaded on a remote sensing apparatus main body having a post shape. The post shaped remote sensing apparatus main body can be stuck into the ground or airdropped and fixed to a place that is difficult to explore directly. Next, the remote sensing apparatus can continuously perform an exploration mission using the drone loaded thereon.

Remote sensing is sensing target objects or areas from a remote place and investigating information thereon, and refers to integrative techniques which collect information about phenomena or target objects without direct measurement and analyze the information using image processing, information extraction, synthesis, identifying, classifying, change measuring, etc.

Remote sensing is directed to collect information about phenomena of target objects by identifying characteristics of electromagnetic waves reflected or radiated from the target objects on the surface of the earth using exploration systems mainly loaded on airplanes or satellite. The remote sensing can collect information of wide areas at one time, data of areas where it is difficult to reach geographically, data of the same areas periodically, and data which is not visible by using optical or/and electronic sensors. Thus, the remote sensing using satellite is preferred due to the above-described advantages.

A remote sensing satellite is a satellite which is loaded with an exploration system configured to obtain information about the weather, environment, topography, and the like of a specific area. The remote sensing satellites refer to an earth exploration satellite, a marine exploration satellite, a meteorological satellite, and the like based on use, and an orbit and altitude thereof can be variously determined according to purposes thereof.

A remote sensing activity using a satellite is recognized as an activity to quickly and accurately obtain information which is needed for humans in life such as weather, an environment, resources, disaster analysis, and geographic information of a specific area. As demand for information collected by remote sensing increases for various industrial fields such as resource exploration, urban planning, civil engineering, the military, leading countries rush to commercialize the technique.

As described above, exploration has been conventionally performed by a remote sensing satellite, however, the remote sensing satellite was very costly, and in addition, the remote sensing satellite was not suitable for precisely exploring a narrow area even though it was suitable for exploring a wide area.

Meanwhile, recently, an unmanned exploration technique using a drone (or quadrotor) which is a small unmanned aerial vehicle capable of precisely exploring a required area has been used, in order to compensate for the problems of the remote sensing satellite.

However, since such a drone needs periodic charging and a temporary station when not exploring, a configuration therefore is insufficient, conventionally. Thus there is a difficulty in performing long term exploration.

### PRIOR ART

Patent

Patent 1: Korean Patent No. 10-0286520

Patent 2: Korean Patent No. 10-0286521

### SUMMARY OF THE INVENTION

The present invention is directed to an apparatus for remote sensing using a drone which is a probe, is unified with a drone station configured to charge and contain the drone, is installed in an exploration site, and stably explores for a long time.

According to an aspect of the present invention, there is provided to an apparatus for remote sensing using a drone, including: a drone station which communicates with a server through a satellite and includes a containment portion at an upper portion and a post portion at a lower portion; and a drone which is contained in a containment portion of the drone station and communicates with the drone station, and further comprising: a solar panel which is installed at the drone station and converts solar energy into electric energy; an capacitor which is installed at the drone station and stores electric energy generated by the solar panel; and a charging container access deck which is installed at the containment portion and charges the drone.

Here, the solar panel may be foldably installed.

In addition, the apparatus for remote sensing using a drone may further include a parachute which is installed at the drone station.

In addition, the apparatus for remote sensing using a drone may further include a water level installed at the drone station.

In addition, the apparatus for remote sensing using a drone may further include a telescopic postural correction leg which is installed at the drone station and corrects a posture of the drone station to an exactly vertical state when the water level is in a non-horizontal state.

### BRIEF DESCRIPTION OF THE SEVERAL VIEWS OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a view illustrating an entire configuration of an apparatus for remote sensing using a drone according to an embodiment of the present invention;

FIG. 2 is a view illustrating a state in which a containment portion of the apparatus for remote sensing using a drone according to an embodiment of the present invention is opened;

FIG. 3 is a view illustrating a state in which a solar panel of the apparatus for remote sensing using a drone according to an embodiment of the present invention is unfolded;

FIG. 4 is a view illustrating a state in which the apparatus for remote sensing using a drone according to an embodiment of the present invention is airdropped; and

FIG. 5 is a view illustrating a process of postural correction of the apparatus for remote sensing using a drone according to an embodiment of the present invention.

### DESCRIPTION OF SPECIFIC EMBODIMENTS OF THE INVENTION

The terminology used herein to describe embodiments of the invention is not intended to limit the scope of the invention. The articles “a,” “an,” and “the” are singular in that they have a single referent, however, the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, numbers, steps, operations, elements, and/or components, but do not preclude the presence or addition of one or more other features, numbers, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

Hereinafter, an embodiment of the present invention will be described.

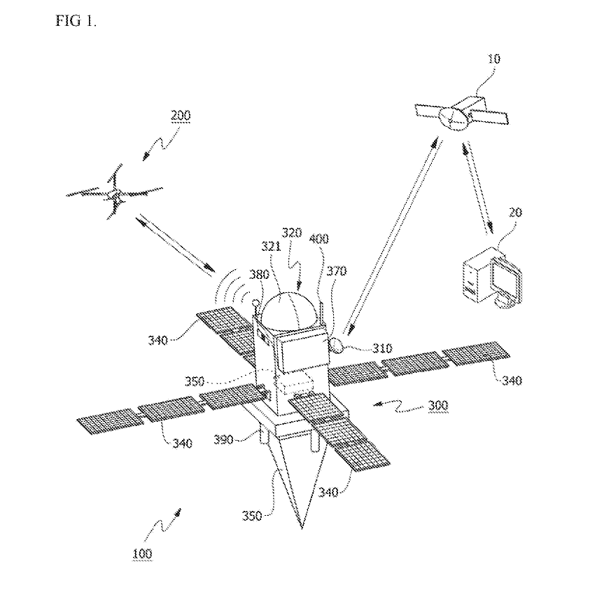

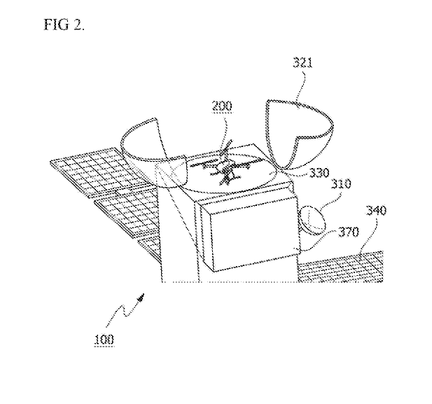

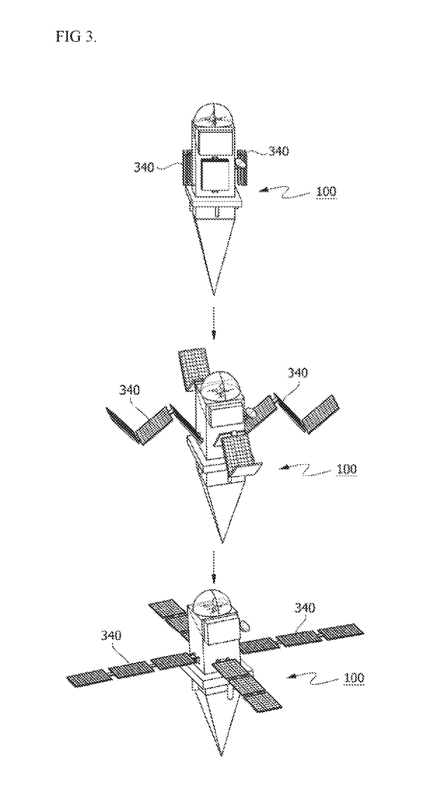

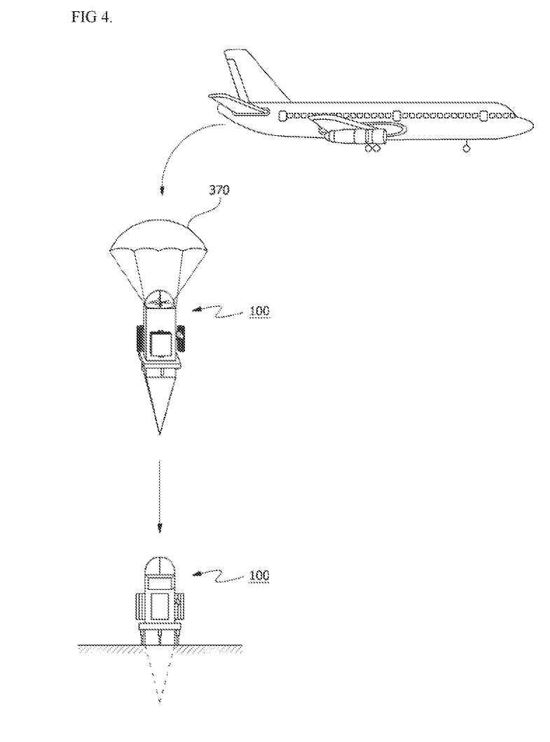

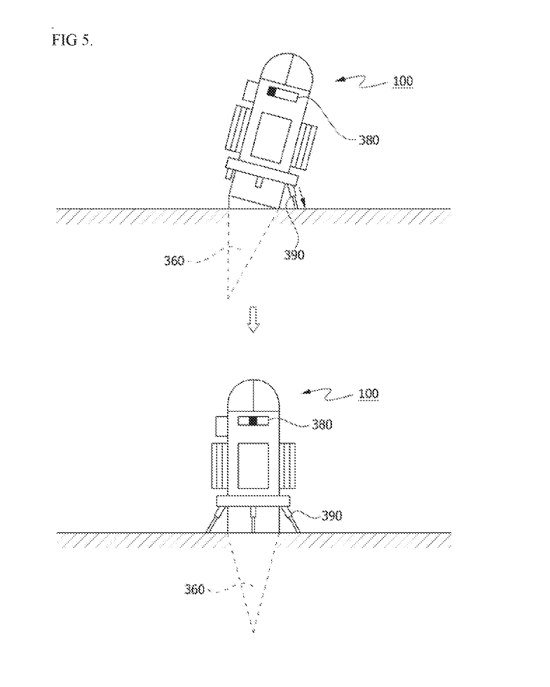

FIG. 1 is a view illustrating an entire configuration of an apparatus for remote sensing using a drone according to an embodiment of the present invention, FIG. 2 is a view illustrating a state in which a containment portion of the apparatus for remote sensing using a drone according to an embodiment of the present invention is opened, FIG. 3 is a view illustrating a state in which a solar panel of the apparatus for remote sensing using a drone according to an embodiment of the present invention is unfolded, FIG. 4 is a view illustrating a state in which the apparatus for remote sensing using a drone according to an embodiment of the present invention is airdropped, and FIG. 5 is a view illustrating a process of postural correction of the apparatus for remote sensing using a drone according to an embodiment of the present invention.

Referring to FIGS. 1, 2, 3, 4 and 5, an apparatus for remote sensing using a drone (hereinafter, referred to as ‘sensing apparatus’) 100 according to an embodiment of the present invention includes a drone 200 and a drone station 300 which supports the drone.

The drone 200 includes a camera (not shown), a transmission unit configured to transmit image data captured by the camera to the drone station 300, and a communication unit configured to communicate with the drone station. In addition, the drone 200 includes a rechargeable battery.

A satellite antenna 310 is provided at the drone station 300, and the drone station 300 may transmit or receive information to or from a server 20 through a satellite 10, and may transmit image data received from the drone 200 to the server 20 and receive control commands from the server 20. The control commands received from the server 20 may be applied to control the drone 200.

In addition, the drone station 300 includes a containment portion 320 configured to contain the drone 200. The containment portion 320, which serves as a temporary station of the drone 100, is equipped, as necessary, with a door 321 which may open or close the containment portion 320 and protect the drone 200.

In addition, a charging container access deck 330 configured to manually or automatically charge the drone 200 when the drone 200 is seated may be installed inside the containment portion 320. It is preferable that an automatic charger be applied because the sensing apparatus is used for unmanned exploration. Here, when the drone 200 is seated at a predetermined position of the containment portion 320, a connection terminal of the drone 200 may connect to the charger and the automatic charger may charge the drone, and alternatively, the automatic charger may also charge the drone 200 using wireless contact between the charger and the drone 200.

In addition, a solar panel 340 which converts solar energy into electric energy may be installed at the outside of the drone station 300 to charge the charging container access deck 330. That is, the solar panel 340 has a semiconductor PN junction. When light having energy greater than that of a forbidden gap is radiated, electrons and holes are generated. Here, an electric field formed at the junction moves the electrons to the N-type semiconductor and moves the holes to the P-type semiconductor and generates an electromotive force. The electromotive force is used as a fuel for the drone 200.

In addition, a capacitor 350 configured to store electric energy generated by the solar panel 340 may be installed at the drone station 300. The capacitor 350 may be used for supplying power to the remote sensing apparatus or the drone, store the remaining electric energy for later use, and may use the electric energy when it is difficult to produce electric power using solar heat due to an influence of weather.

In addition, the drone station 300 includes a post portion 360 at a lower portion thereof. The post portion 360 is formed in an increasingly sharper shape toward the lower end thereof, and is stuck in the surface of the earth when the sensing apparatus 100 is airdropped toward the ground as illustrated in FIG. 4. Particularly, it is preferable that the weight of the post portion 360 is greater than that of the other portion of the sensing apparatus 100 so that the post portion 360 is vertically stuck when stuck in the surface of the earth.

In addition, a parachute 370 may be installed at the drone station 300. Since the sensing apparatus 100 falls toward the ground when airdropped, the parachute 370 is needed to reduce the speed thereof and needed for the post portion 360 to be stuck upright in the surface of the earth. It may be preferable that a speed sensor (not shown) is installed at the drone station 300, and the parachute is automatically released when speed thereof is equal to or greater than a predetermined value.

In addition, a water level 380 may be installed at the drone station 300. The water level 380 senses whether the sensing apparatus 100 is exactly vertical or not when stuck in the surface of the earth. When the water level 380 is not in a horizontal state, since a containing state of the drone 200 may also be poor, a posture of the drone 200 is corrected by the postural correction leg which will be described below.

In addition, three or four telescopic postural correction legs 390 may be installed at the drone station 300. When the sensing apparatus 100 is non-horizontally stuck in the surface of the earth, the sensing apparatus 100 is vertically stood while a postural correction leg 390 positioned at a side in which the sensing apparatus 100 is inclined is lengthened as illustrated in FIG. 5.

Here, as the water level 380 and the postural correction legs 390 are in electrically connection with each other, the postural correction leg is lengthened until the water level 380 has a normal value. Accordingly, the inclined state of the sensing apparatus 100 is corrected into a vertical state thereof. Next, the postural correction legs 390 are simultaneously lengthened, and the vertical state of the sensing apparatus 100 is securely maintained.

A non-described numeral 400 is a GPS antenna for location tracking of the sensing apparatus 100.

As described above, the present invention has an advantage that an apparatus for remote sensing which unifies a drone and a drone station including an infrastructure configured to charge and contain the drone, such as a settling portion by which the drone is stably settled on the ground when airdropped, a charging portion using solar energy, and a loading portion on which the drone is loaded, is input to an exploration site, and thus an exploration activity can be stably performed for a long time by electric power being generated using the solar panel possessed by itself without being supplied from the outside, the generated electric power being stored in a capacitor, and supplying the electric power needed for the drone and remote sensing apparatus.

The invention has been described in detail with reference to the exemplary embodiments. However, the exemplary embodiments should be considered in a descriptive sense only, and the invention is not limited thereto. It will be apparent to those skilled in the art that various modifications and improvements within the scope of the invention may be made.

Simple modifications and alterations of the invention fall within the scope of the invention and the scope of the invention is defined by the accompanying claims.

What is claimed is:

1. An apparatus for remote sensing using a drone, comprising:
a drone station which communicates with a server through a satellite and includes a containment portion at an upper portion and a post portion at a lower portion; and
a drone which is contained in the containment portion of the drone station and communicates with the drone station, and
further comprising:
a solar panel which is installed at the drone station and converts solar energy into electric energy;
a capacitor which is installed at the drone station and stores electric energy generated by the solar panel; and
a charging container access deck which is installed at the containment portion and charges the drone.

2. The apparatus for remote sensing using a drone of claim 1, wherein the solar panel is foldably installed.

3. The apparatus for remote sensing using a drone of claim 1, further comprising a parachute which is installed at the drone station.

4. The apparatus for remote sensing using a drone of claim 1, further comprising a water level installed at the drone station.

5. The apparatus for remote sensing using a drone of claim 4, further comprising a telescopic postural correction leg which is installed at the drone station and corrects a posture of the drone station to an exactly vertical state when the water level is in a non-horizontal state.
